(19) United States
(12) Patent Application Publication
(10) Pub. No.: US 2025/0313769 A1
(43) Pub. Date: Oct. 9, 2025

(54) LOW VISCOSITY AND HIGH FLASH POINT PAO SOLVENTS

(71) Applicant: Chevron Phillips Chemical Company LP, The Woodlands, TX (US)

(72) Inventors: Thomas J. Malinski, The Woodlands, TX (US); Spencer A. Kerns, Kingwood, TX (US); Kenneth D. Hope, The Woodlands, TX (US); Steven M. Bischof, Kingwood, TX (US); Michel Sanchez-Rivas, Arquennes (BE); Eric P. Weber, Kingwood, TX (US)

(21) Appl. No.: 19/171,474

(22) Filed: Apr. 7, 2025

Related U.S. Application Data
(60) Provisional application No. 63/631,542, filed on Apr. 9, 2024.
(60) Provisional application No. 63/631,550, filed on Apr. 9, 2024.

(51) Int. Cl. C10M 105/04; C09K 5/04; C10N 30/02

(52) U.S. Cl. CPC C10M 105/04; C09K 5/042; C09K 2205/12; C10M 2203/022; C10N 2030/02

(57) ABSTRACT

A C₁₆ alkane composition containing at least 90 wt. % C₁₆ alkanes and having a 100° C. kinematic viscosity from 0.9 to 1.5 cSt, a 40° C. kinematic viscosity from 2 to 3.6 cSt, and a flash point from 115 to 140° C. and/or a pour point from −60 to −30° C. A C₂₄ alkane composition containing at least 90 wt. % C₂₄ alkanes and having a 100° C. kinematic viscosity from 2 to 3 cSt, a 40° C. kinematic viscosity from 7.7 to 9.7 cSt, and a flash point from 185 to 215° C. and/or a pour point from −95 to −70° C. An alkane composition containing from 5 to 95 wt. % C₁₆ alkanes and from 95 to 5 wt. % C₂₄ alkanes, based on a total weight of the C₁₆ alkanes and the C₂₄ alkanes.

### REFERENCE TO RELATED APPLICATIONS

This application claims the benefit of U.S. Provisional Patent Application Nos. 63/631,542 and 63/631,550, filed on Apr. 9, 2024, the disclosures of which are incorporated herein by reference in their entirety.

### FIELD OF THE INVENTION

The present disclosure relates generally to C₁₆ to C₂₄ alkanes produced from 1-octene dimers and trimers, and more particularly, relates to C₁₆ alkane compositions, C₂₄ alkane compositions, and mixed C₁₆-C₂₄ alkane compositions with beneficial viscosity, flash point, and pour point properties.

### BACKGROUND OF THE INVENTION

Alkanes of various carbon numbers are used as low viscosity solvents in a multitude of applications. However, low flash points and volatility and flammability concerns limit the utility of certain alkanes. Thus, it would be beneficial to develop alkane compositions with both low viscosity and high flash points. Accordingly, it is to these ends that the present invention is generally directed.

### SUMMARY OF THE INVENTION

This summary is provided to introduce a selection of concepts in a simplified form that are further described below in the detailed description. This summary is not intended to identify required or essential features of the claimed subject matter. Nor is this summary intended to be used to limit the scope of the claimed subject matter.

Alkane compositions are described herein. A first composition consistent with this disclosure can comprise at least 90 wt. % C₁₆ alkanes (hydrogenated 1-octene dimers), and in some aspects, at least 95 wt. % or at least 98 wt. % C₁₆ alkanes. The first composition can have a 100° C. kinematic viscosity (KV100) in a range from 0.9 to 1.5 cSt, a 40° C. kinematic viscosity (KV40) in a range from 2 to 3.6 cSt, and a flash point in a range from 115 to 140° C. and/or a pour point in a range from −60 to −30° C.

A second alkane composition provided herein can comprise at least 90 wt. % C₂₄ alkanes (hydrogenated 1-octene trimers), and in some aspects, at least 95 wt. % or at least 98 wt. % C₂₄ alkanes. The second composition can have a KV100 in a range from 2 to 3 cSt, a KV40 in a range from 7.7 to 9.7 cSt, and a flash point in a range from 185 to 215° C. and/or a pour point in a range from −95 to −70° C.

A third alkane composition provided herein can comprise (a) from 5 to 95 wt. % C₁₆ alkanes (hydrogenated 1-octene dimers) and (b) from 95 to 5 wt. % C₂₄ alkanes (hydrogenated 1-octene trimers). The weight percentages are based on these two components, and not the overall composition. Based on the overall composition, however, the third alkane composition can comprise, for example, (a) from 40 to 90 wt. % or from 58 to 80 wt. % of the C₁₆ alkanes and (b) from 10 to 60 wt. % or from 14 to 30 wt. % of the C₂₄ alkanes. As one of skill in the art would readily recognize, the total of these and other components does not exceed 100 wt. %. For instance, the third alkane composition can further comprise (c) from 0.5 to 20 wt. % or from 2 to 8 wt. % C₃₂ alkanes (hydrogenated 1-octene tetramers).

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects and embodiments can be directed to various feature combinations and sub-combinations described in the detailed description.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter can be described such that, within particular aspects, a combination of different features can be envisioned. For each and every aspect and/or feature disclosed herein, all combinations that do not detrimentally affect the compositions, processes, and/or methods described herein are contemplated with or without explicit description of the particular combination. Additionally, unless explicitly recited otherwise, any aspect and/or feature disclosed herein can be combined to describe inventive compositions, processes, and/or methods consistent with the present disclosure.

In this disclosure, while compositions and processes/methods are described in terms of “comprising” various components or steps, the compositions and processes/methods also can “consist essentially of” or “consist of” the various components or steps, unless stated otherwise. The terms “a,” “an,” and “the” are intended to include plural alternatives, e.g., at least one, unless otherwise specified. For instance, the disclosure of “an additive” is meant to encompass one additive, or combinations of two or more additives, unless otherwise specified.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound or group disclosed herein, any name or structure (general or specific) presented is intended to encompass all conformational isomers, regioisomers, stereoisomers, and mixtures thereof that can arise from a particular set of substituents, unless otherwise specified. The name or structure (general or specific) also encompasses all enantiomers, diastereomers, and other optical isomers (if there are any) whether in enantiomeric or racemic forms, as well as mixtures of stereoisomers, as would be recognized by a skilled artisan, unless otherwise specified. For instance, a general reference to pentane includes n-pentane, 2-methyl-butane, and 2,2-dimethylpropane; and a general reference to a butyl group includes a n-butyl group, a sec-butyl group, an iso-butyl group, and a t-butyl group.

The terms “contacting” and “combining” and the like are used herein to describe compositions and processes/methods in which the materials or components are contacted or combined together in any order, in any manner, and for any length of time, unless otherwise specified. For example, the materials or components can be blended, mixed, slurried, dissolved, reacted, treated, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates that the presence of one or more halogen atoms replacing an equivalent number of hydrogen atoms in the hydrocarbon).

The term “alkane” refers to a saturated hydrocarbon compound. The alkane can be linear, branched, or cyclic. Therefore, alkane compositions can include linear alkanes, or branched alkanes, or cyclic alkanes, or mixtures or combinations of linear alkanes, branched alkanes, and cyclic alkanes.

The term “olefin” refers to hydrocarbons that have at least one carbon-carbon double bond that is not part of an aromatic ring or an aromatic ring system. The term “olefin” includes aliphatic and aromatic, cyclic and acyclic, and/or linear and branched hydrocarbons having at least one carbon-carbon double bond that is not part of an aromatic ring or ring system unless specifically stated otherwise. Olefins having only one, only two, only three, etc., carbon-carbon double bonds can be identified by use of the term “mono,” “di,” “tri,” etc., within the name of the olefin. The olefins can be further identified by the position of the carbon-carbon double bond(s).

The term “alpha olefin” refers to any olefin that has a carbon-carbon double bond between the first and second carbon atom of the longest contiguous chain of carbon atoms. The term “alpha olefin” includes linear and branched alpha olefins and alpha olefins which can have more than one non-aromatic carbon-carbon double bond, unless expressly stated otherwise. The term “normal alpha olefin” refers to a linear aliphatic hydrocarbon mono-olefin having a carbon-carbon double bond between the first and second carbon atoms. The term “linear internal olefin” refers to a linear aliphatic hydrocarbon mono-olefin having a double bond that is not between the first and second carbon atom.

The term oligomer refers to a product that contains from 2 to 20 monomer units. The terms “oligomerization product” and “oligomer product” include all products made by the “oligomerization” process, including the “oligomers” and products which are not “oligomers” (e.g., products which contain more than 20 monomer units, or solid polymer), but exclude other non-oligomer components of an oligomerization reactor effluent stream, such as unreacted monomer, organic reaction medium, and hydrogen, amongst other components. The oligomer product generally refers to a composition prior to hydrogenation. These terms also can be used generically herein to include homo-oligomers, co-oligomers, and so forth.

A “polyalphaolefin” (PAO) is a mixture of hydrogenated (or alternatively, substantially saturated) oligomers, containing units derived from an alpha olefin monomer. Unless specified otherwise, the PAO can contain units derived from alpha olefin monomer units, which can be the same (hydrogenated or substantially saturated alpha olefin homo-oligomer) or can be different (hydrogenated or substantially saturated alpha olefin co-oligomer). Generally, the alpha olefin monomer utilized to produce the polyalphaolefin can be any alpha olefin monomer described herein. One having ordinary skill in the art would recognize that the processes for producing the PAO can leave some hydrogenated monomer in the PAO (e.g., less than 1 wt. % based on the total amount of the PAO), and this quantity of hydrogenated monomer can be specified.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, when a chemical moiety having a certain number of carbon atoms is disclosed or claimed, the intent is to disclose or claim individually every possible number that such a range could encompass, consistent with the disclosure herein. For example, the disclosure that a compound is a C₁₆ to C₂₄ alkane, or in alternative language, an alkane having from 16 to 24 carbon atoms, as used herein, refers to a compound that can have 16, 17, 18, 19, 20, 21, 22, 23, or 24 carbon atoms, as well as any range between these two numbers (for example, a C₁₆ to C₂₄ alkane), and also including any combination of ranges between these two numbers (for example, a C₁₆ to C₁₈ and a C₂₂ to C₂₄ alkane).

Similarly, another representative example follows for the 40° C. kinematic viscosity (KV40) of a C₁₆ alkane composition consistent with aspects of this invention. By a disclosure that KV40 is in a range from 2 to 3.6 cSt, the intent is to recite that KV40 can be any value in the range and, for example, can include any range or combination of ranges from 2 to 3.6 cSt, such as from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt, and so forth. Likewise, all other ranges disclosed herein should be interpreted in a manner similar to these examples.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

C₁₆ alkane compositions, C₂₄ alkane compositions, and mixed C₁₆-C₂₄ alkane compositions are disclosed herein. These compositions can be derived from 1-octene dimers and trimers (and optionally, tetramers) which are produced from the oligomerization of 1-octene, followed by isolating the particular carbon number fraction or fractions, and then hydrogenating. A metallocene catalyst can be utilized as the oligomerization catalyst to form the 1-octene oligomers, although other catalyst systems can be employed.

An objective of the present invention is to produce an alkane composition having a beneficial combination of both a low viscosity and a high flash point, particularly as compared to conventional n-alkanes or polyalphaolefins (PAOs) of the same carbon number.

Another objective of the present invention is to produce an alkane composition having a beneficial combination of both a low viscosity and a low pour point, particularly as compared to conventional n-alkanes or polyalphaolefins (PAOs) of the same carbon number.

Yet another objective is to produce an alkane composition that remains in the liquid phase over a wide range of temperatures and storage conditions. For instance, the alkane composition can have a beneficial combination of both a low pour point and a high flash point, particularly as compared to conventional n-alkanes or polyalphaolefins (PAOs) of the same carbon number.

Further benefits of the disclosed alkane compositions include a high degree of saturation, high oxidative stability and chemical inertness, high heat capacity, low electrical conductivity, and low density (low specific gravity).

### C₁₆ Alkane Compositions

A first alkane composition disclosed herein can comprise at least 90 wt. % C₁₆ alkanes (hydrogenated 1-octene dimers), and this first alkane composition can be characterized by a 100° C. kinematic viscosity (KV100) in a range from 0.9 to 1.5 cSt, a 40° C. kinematic viscosity (KV40) in a range from 2 to 3.6 cSt, and a flash point in a range from 115 to 140° C. and/or a pour point in a range from −60 to −30° C. In some aspects, the first composition can comprise at least 92 wt. % C₁₆ alkanes, at least 95 wt. % C₁₆ alkanes, at least 97 wt. % C₁₆ alkanes, at least 98 wt. % C₁₆ alkanes, or at least 99 wt. % C₁₆ alkanes. Therefore, illustrative and non-limiting ranges for the amount of C₁₆ alkanes in the first composition can include from 90 to 99.5 wt. %, from 92 to 99 wt. %, from 95 to 99.9 wt. %, from 97 to 99.5 wt. %, from 98 to 99.9 wt. %, or from 99 to 99.9 wt. %, and the like.

Stated another way, the first alkane composition can comprise monomer units derived from 1-octene. The repeating units of the first alkane composition can be predominantly 1-octene monomer units. Accordingly, the first alkane composition can comprise at least 90 wt. %, and more often, at least 92 wt. %, at least 95 wt. %, at least 97 wt. %, or at least 98 wt. % 1-octene monomer units. Thus, for example, the first alkane composition can comprise at least 99 wt. % (or 100 wt. %) 1-octene monomer units.

The first alkane composition has a 100° C. kinematic viscosity (KV100) that generally falls within a range from 0.9 to 1.5 cSt. For instance, the first alkane composition can have a minimum KV100 of 0.9, 1, or 1.1 cSt; additionally or alternatively, the maximum KV100 of the first alkane composition can be 1.5, 1.4, or 1.3 cSt. Generally, the 100° C. kinematic viscosity of the first alkane composition can be in a range from any minimum KV100 disclosed herein to any maximum KV100 disclosed herein. Therefore, suitable non-limiting ranges for the 100° C. kinematic viscosity of the first alkane composition can include the following ranges: from 1 to 1.5 cSt, from 1 to 1.4 cSt, from 1 to 1.3 cSt, from 1.1 to 1.5 cSt, from 1.1 to 1.4 cSt, or from 1.1 to 1.3 cSt. KV100 is determined in accordance with ASTM D7042-04.

The 40° C. kinematic viscosity (KV40) of the first alkane composition can fall within a range from 2 to 3.6 cSt. For instance, the first alkane composition can have a minimum KV40 of 2, 2.2, 2.4, 2.6, or 2.7 cSt; additionally or alternatively, the maximum KV40 of the first alkane composition can be 3.6, 3.4, 3.2, 3, or 2.9 cSt. Generally, the 40° C. kinematic viscosity of the first alkane composition can be in a range from any minimum KV40 disclosed herein to any maximum KV40 disclosed herein. Therefore, suitable non-limiting ranges for the 40° C. kinematic viscosity of the first alkane composition can include the following ranges: from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt. KV40 is determined in accordance with ASTM D7042-04.

The flash point of the first alkane composition typically ranges from 115 to 140° C. For instance, the minimum flash point of the first alkane composition can be 115, 120, or 125° C.; additionally or alternatively, the maximum flash point can be 140, 135, or 130° C. Generally, the flash point of the first alkane composition can be in a range from any minimum flash point temperature disclosed herein to any maximum flash point temperature disclosed herein. Therefore, suitable non-limiting ranges for the flash point of the first alkane composition can include the following ranges: from 115 to 135° C., from 115 to 130° C., from 120 to 140° C., from 120 to 135° C., from 120 to 130° C., from 125 to 135° C., or from 125 to 130° C. The flash point is determined in accordance with ASTM D92.

The pour point of the first alkane composition typically can fall within a range from −60 to −30° C. For instance, the minimum pour point of the first alkane composition can be −60, −55, or −50° C.; additionally or alternatively, the maximum pour point can be −30, −35, or −40° C. Generally, the pour point of the first alkane composition can be in a range from any minimum pour point temperature disclosed herein to any maximum pour point temperature disclosed herein. Therefore, suitable non-limiting ranges for the pour point of the first alkane composition can include the following ranges: from −60 to −35° C., from −60 to −40° C., from −55 to −30° C., from −55 to −35° C., from −55 to −40° C., from −50 to −30° C., from −50 to −35° C., or from −50 to −40° C. The pour point is determined in accordance with ASTM D5950.

While not limited thereto, the first alkane composition often has a density at 15° C. in a range of from 0.773 to 0.782 g/cc. In an aspect, the first alkane composition can have a minimum density of 0.773, 0.774, 0.775, 0.776, or 0.777 g/cc; additionally or alternatively, the maximum density of the first alkane composition can be 0.782, 0.781, 0.780, 0.779, or 0.778 g/cc. Generally, the 15° C. density of the first alkane composition can be in a range from any minimum density disclosed herein to any maximum density disclosed herein. Therefore, suitable non-limiting ranges for the density at 15° C. of the first alkane composition can include the following ranges: from 0.774 to 0.781 g/cc, from 0.775 to 0.780 g/cc, from 0.776 to 0.779 g/cc, from 0.776 to 0.778 g/cc, from 0.777 to 0.779 g/cc, or from 0.777 to 0.778 g/cc. Density is determined in accordance with ASTM D4052.

### C₂₄ Alkane Compositions

A second alkane composition disclosed herein can comprise at least 90 wt. % C₂₄ alkanes (hydrogenated 1-octene trimers), and this second alkane composition can be characterized by a 100° C. kinematic viscosity (KV100) in a range from 2 to 3 cSt, a 40° C. kinematic viscosity (KV40) in a range from 7.7 to 9.7 cSt, and a flash point in a range from 185 to 215° C. and/or a pour point in a range from −95 to −70° C. In some aspects, the second composition can comprise at least 92 wt. % C₂₄ alkanes, at least 95 wt. % C₂₄ alkanes, at least 97 wt. % C₂₄ alkanes, at least 98 wt. % C₂₄ alkanes, or at least 99 wt. % C₂₄ alkanes. Therefore, illustrative and non-limiting ranges for the amount of C₂₄ alkanes in the second composition can include from 90 to 99.5 wt. %, from 92 to 99 wt. %, from 95 to 99.9 wt. %, from 97 to 99.5 wt. %, from 98 to 99.9 wt. %, or from 99 to 99.9 wt. %, and the like.

Stated another way, the second alkane composition can comprise monomer units derived from 1-octene. The repeating units of the second alkane composition can be predominantly 1-octene monomer units. Accordingly, the second alkane composition can comprise at least 90 wt. %, and more often, at least 92 wt. %, at least 95 wt. %, at least 97 wt. %, or at least 98 wt. % 1-octene monomer units. Thus, for example, the second alkane composition can comprise at least 99 wt. % (or 100 wt. %) 1-octene monomer units.

The second alkane composition has a 100° C. kinematic viscosity (KV100) that generally falls within a range from 2 to 3 cSt. For instance, the second alkane composition can have a minimum KV100 of 2, 2.1, 2.2, 2.3, or 2.4 cSt; additionally or alternatively, the maximum KV100 of the second alkane composition can be 3, 2.9, 2.8, 2.7, 2.6, or 2.5 cSt. Generally, the 100° C. kinematic viscosity of the second alkane composition can be in a range from any minimum KV100 disclosed herein to any maximum KV100 disclosed herein. Therefore, suitable non-limiting ranges for the 100° C. kinematic viscosity of the second alkane composition can include the following ranges: from 2.1 to 2.9 cSt, from 2.2 to 2.8 cSt, from 2.3 to 2.7 cSt, from 2.3 to 2.6 cSt, from 2.3 to 2.5 cSt, from 2.4 to 2.7 cSt, from 2.4 to 2.6 cSt, or from 2.4 to 2.5 cSt. KV100 is determined in accordance with ASTM D7042-04.

The 40° C. kinematic viscosity (KV40) of the second alkane composition can fall within a range from 7.7 to 9.7 cSt. For instance, the second alkane composition can have a minimum KV40 of 7.7, 7.8, 7.9, 8, 8.1, 8.2, 8.3, 8.4, 8.5, or 8.6 cSt; additionally or alternatively, the maximum KV40 of the second alkane composition can be 9.7, 9.6, 9.5, 9.4, 9.3, 9.2, 9.1, 9, 8.9, or 8.8 cSt. Generally, the 40° C. kinematic viscosity of the second alkane composition can be in a range from any minimum KV40 disclosed herein to any maximum KV40 disclosed herein. Therefore, suitable non-limiting ranges for the 40° C. kinematic viscosity of the second alkane composition can include the following ranges: from 7.8 to 9.6 cSt, from 7.9 to 9.5 cSt, from 8 to 9.4 cSt, from 8.1 to 9.3 cSt, from 8.2 to 9.2 cSt, from 8.3 to 9.1 cSt, from 8.4 to 9 cSt, from 8.5 to 8.9 cSt, or from 8.6 to 8.8 cSt. KV40 is determined in accordance with ASTM D7042-04.

The flash point of the second alkane composition typically ranges from 185 to 215° C. For instance, the minimum flash point of the second alkane composition can be 185, 188, 190, 192, or 194° C.; additionally or alternatively, the maximum flash point can be 215, 205, 202, 200, or 198° C. Generally, the flash point of the second alkane composition can be in a range from any minimum flash point temperature disclosed herein to any maximum flash point temperature disclosed herein. Therefore, suitable non-limiting ranges for the flash point of the second alkane composition can include the following ranges: from 185 to 205° C., from 185 to 200° C., from 188 to 202° C., from 190 to 215° C., from 190 to 205° C., from 192 to 200° C., or from 194 to 198° C. The flash point is determined in accordance with ASTM D92.

The pour point of the second alkane composition typically can fall within a range from −95 to −70° C. For instance, the minimum pour point of the second alkane composition can be −95, −90, −88, or −85° C.; additionally or alternatively, the maximum pour point can be −70, −75, −78, or −80° C. Generally, the pour point of the second alkane composition can be in a range from any minimum pour point temperature disclosed herein to any maximum pour point temperature disclosed herein. Therefore, suitable non-limiting ranges for the pour point of the second alkane composition can include the following ranges: from −90 to −70° C., from −90 to −75° C., from −88 to −75° C., from −88 to −78° C., or from −85 to −80° C. The pour point is determined in accordance with ASTM D5950.

While not limited thereto, the second alkane composition often has a density at 15° C. in a range of from 0.799 to 0.808 g/cc. In an aspect, the second alkane composition can have a minimum density of 0.799, 0.800, 0.801, 0.802, or 0.803 g/cc; additionally or alternatively, the maximum density of the second alkane composition can be 0.808, 0.807, 0.806, 0.805, or 0.804 g/cc. Generally, the 15° C. density of the second alkane composition can be in a range from any minimum density disclosed herein to any maximum density disclosed herein. Therefore, suitable non-limiting ranges for the density at 15° C. of the second alkane composition can include the following ranges: from 0.799 to 0.808 g/cc, from 0.800 to 0.807 g/cc, from 0.801 to 0.806 g/cc, from 0.802 to 0.805 g/cc, from 0.802 to 0.804 g/cc, from 0.803 to 0.805 g/cc, or from 0.803 to 0.804 g/cc. Density is determined in accordance with ASTM D4052.

### C₁₆-C₂₄ Alkane Compositions

A third alkane composition disclosed herein can comprise (a) from 5 to 95 wt. % C₁₆ alkanes (hydrogenated 1-octene dimers), and (b) from 95 to 5 wt. % C₂₄ alkanes (hydrogenated 1-octene trimers), and these weight percentages are based on the total weight of the C₁₆ alkanes and the C₂₄ alkanes. For instance, the third alkane composition can have a minimum amount of C₁₆ alkanes of 5, 10, 15, 25, 35, or 50 wt. %; additionally or alternatively, the maximum amount of C₁₆ alkanes in the third alkane composition can be 95, 90, 85, 75, or 65 wt. %. Generally, the amount of the C₁₆ alkanes in the third alkane composition can be in a range from any minimum amount disclosed herein to any maximum amount disclosed herein. Therefore, suitable non-limiting ranges for the amount of the C₁₆ alkanes in the third alkane composition can include the following ranges: from 10 to 90 wt. %, from 50 to 90 wt. %, from 15 to 85 wt. %, from 50 to 85 wt. %, from 25 to 75 wt. %, or from 35 to 65 wt. %, of the C₁₆ alkanes. As above, these weight percentages are based on the total weight of the C₁₆ alkanes and the C₂₄ alkanes.

Additionally or alternatively, the third alkane composition can comprise, based on the total weight of the composition, (a) from 40 to 90 wt. % of the C₁₆ alkanes (hydrogenated 1-octene dimers) and (b) from 10 to 60 wt. % of the C₂₄ alkanes (hydrogenated 1-octene trimers). Based on the total weight of the composition, other suitable amounts of the C₁₆ alkanes in the third alkane composition can include, but are not limited to, from 50 to 85 wt. %, from 55 to 95 wt. %, or from 58 to 80 wt. % of the C₁₆ alkanes. Additionally or alternatively, based on the total weight of the composition, other suitable amounts of the C₂₄ alkanes in the third alkane composition can include, but are not limited to, from 10 to 50 wt. %, from 10 to 30 wt. %, or from 14 to 30 wt. % of the C₂₄ alkanes. As one of skill in the art would readily recognize, the total of these and other components does not exceed 100 wt. %.

Optionally, the third alkane composition can further comprise (c) C₃₂ alkanes (hydrogenated 1-octene tetramers). When present, the amount of the C₃₂ alkanes in the third composition can fall within a range from 0.5 to 20 wt. % C₃₂ alkanes, based on the total weight of the composition. Other suitable amounts of the C₃₂ alkanes in the third alkane composition can include, but are not limited to, from 1 to 12 wt. %, from 1 to 9 wt. %, or from 2 to 8 wt. % C₃₂ alkanes. These weight percentages are based on the total weight of the third alkane composition.

The third alkane composition has a 100° C. kinematic viscosity (KV100) that generally falls within a range from 1 to 2.9 cSt. For instance, the third alkane composition can have a minimum KV100 of 1, 1.1, 1.2, or 1.3 cSt; additionally or alternatively, the maximum KV100 of the third alkane composition can be 2.9, 2.5, 2, or 1.6 cSt. Generally, the 100° C. kinematic viscosity of the third alkane composition can be in a range from any minimum KV100 disclosed herein to any maximum KV100 disclosed herein. Therefore, suitable non-limiting ranges for the 100° C. kinematic viscosity of the third alkane composition can include the following ranges: from 1 to 2.9 cSt, from 1 to 2.5 cSt, from 1 to 2 cSt, from 1 to 1.6 cSt, from 1.1 to 2.5 cSt, from 1.1 to 2 cSt, from 1.1 to 1.6 cSt, from 1.2 to 2.5 cSt, from 1.2 to 2 cSt, from 1.3 to 2.9 cSt, or from 1.3 to 2.5 cSt. KV100 is determined in accordance with ASTM D7042-04.

The 40° C. kinematic viscosity (KV40) of the third alkane composition can fall within a range from 2 to 9.5 cSt. For instance, the third alkane composition can have a minimum KV40 of 2, 2.5, 3, or 4 cSt; additionally or alternatively, the maximum KV40 of the third alkane composition can be 9.5, 9, 8.5, 8, 7, 6, 5, or 4 cSt. Generally, the 40° C. kinematic viscosity of the third alkane composition can be in a range from any minimum KV40 disclosed herein to any maximum KV40 disclosed herein. Therefore, suitable non-limiting ranges for the 40° C. kinematic viscosity of the third alkane composition can include the following ranges: from 2 to 9.5 cSt, from 2 to 8.5 cSt, from 2.5 to 8.5 cSt, from 2.5 to 7 cSt, from 2.5 to 5 cSt, from 2.5 to 4 cSt, from 3 to 8 cSt, from 3 to 6 cSt, from 4 to 9 cSt, or from 4 to 6 cSt. KV40 is determined in accordance with ASTM D7042-04.

The flash point of the third alkane composition typically ranges from 100 to 200° C. For instance, the minimum flash point of the third alkane composition can be 100, 120, 130, or 140° C.; additionally or alternatively, the maximum flash point can be 200, 190, 180, 160, or 150° C. Generally, the flash point of the third alkane composition can be in a range from any minimum flash point temperature disclosed herein to any maximum flash point temperature disclosed herein. Therefore, suitable non-limiting ranges for the flash point of the third alkane composition can include the following ranges: from 100 to 200° C., from 100 to 150° C., from 120 to 180° C., from 120 to 160° C., from 130 to 190° C., from 130 to 160° C., or from 140 to 180° C. The flash point is determined in accordance with ASTM D92.

The pour point of the third alkane composition typically can fall within a range from −85 to −35° C. For instance, the minimum pour point of the third alkane composition can be −85, −80, −75, or −70° C.; additionally or alternatively, the maximum pour point can be −35, −40, or −45° C. Generally, the pour point of the third alkane composition can be in a range from any minimum pour point temperature disclosed herein to any maximum pour point temperature disclosed herein. Therefore, suitable non-limiting ranges for the pour point of the third alkane composition can include the following ranges: from −85 to −35° C., from −80 to −40° C., from −75 to −40° C., from −75 to −45° C., or from −70 to −45° C. The pour point is determined in accordance with ASTM D5950.

While not limited thereto, the third alkane composition often has a density at 15° C. in a range of from 0.776 to 0.805 g/cc. In an aspect, the third alkane composition can have a minimum density of 0.776, 0.778, or 0.780 g/cc; additionally or alternatively, the maximum density of the third alkane composition can be 0.805, 0.803, 0.800, 0.795, or 0.790 g/cc. Generally, the 15° C. density of the third alkane composition can be in a range from any minimum density disclosed herein to any maximum density disclosed herein. Therefore, suitable non-limiting ranges for the density at 15° C. of the third alkane composition can include the following ranges: from 0.776 to 0.805 g/cc, from 0.778 to 0.803 g/cc, from 0.778 to 0.790 g/cc, from 0.780 to 0.803 g/cc, from 0.780 to 0.800 g/cc, from 0.780 to 0.795 g/cc, or from 0.780 to 0.790 g/cc. Density is determined in accordance with ASTM D4052.

### Fluid Compositions

Fluid compositions also are encompassed herein. Such fluid compositions can comprise any of the alkane compositions described herein and an additive (one additive, two or more additives). For instance, in one aspect, the fluid composition can comprise the first C₁₆ alkane composition and an additive (one additive, two or more additives). In another aspect, the fluid composition can comprise the second C₂₄ alkane composition and an additive (one additive, two or more additives). In yet another aspect, the fluid composition can comprise the third C₁₆-C₂₄ alkane composition and an additive (one additive, two or more additives).

In addition to the alkane composition, the fluid composition can contain any suitable amount of a single additive or any suitable amounts of two or more additives. As those skilled in the art would readily recognize, the specific additive (or additives) can be included to impart specific properties to the fluid compositions (or the alkane compositions), depending of course upon the end-use application for the fluid compositions (or the alkane compositions). Illustrative and non-limiting examples of suitable additives can include an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, or a thickener. Any combination of two or more of these additives also can be present.

As to additives that can be utilized along with the alkane compositions and be present in the fluid compositions, general information on additives that can be used herein can be found in “Lubricants and Lubrications,” T. Mang and W. Dresel, eds., Wiley-VCH GmbH, Weinheim (2001); “Lubrication Fundamentals,” Second Edition, Revised and Expanded, ExxonMobil Lubricants and Specialties, D.M. Pirro, A.A. Wessol, CRC Press 2001; “Fuels and Lubricants Handbook: Technology, Properties, Performance, and Testing” edited by George E. Totten, Steven R. Westbrook, Rajesh J. Shah, ASTM (2003), ISBN 0-8031-2096-6; Chapter 9 Additives and Additive Chemistry, pp. 199-248, “Lubricants and Related Products,” Klamann, Verlag Chemie, Deerfield Beach, FL, ISBN 0-89573-177-0; “Lubricant Additives” by M. W. Ranney, published by Noyes Data Corporation of Parkridge, N.J. (1973); and “Lubricant Additives,” C. V. Smallheer and R. K. Smith, published by the Lezius-Hiles Co. of Cleveland, OH (1967).

Viscosity index improvers (also known as viscosity modifiers and viscosity improvers) can provide fluid compositions with high and low temperature operability. These additives can impart shear stability at elevated temperatures and acceptable viscosity at low temperatures. Suitable viscosity index improvers can include high molecular weight hydrocarbons, olefin polymers and copolymers, polyesters, and viscosity index improver dispersants that function as both a viscosity index improver and a dispersant. Viscosity index improvers can have molecular weights ranging from 10,000 Da to 1,000,000 Da, from 20,000 Da to 500,000 Da, or from 50,000 Da to 200,000 Da.

Viscosity index improvers can include polymers and copolymers of methacrylate, butadiene, olefins, or alkylated styrenes. Exemplary viscosity index improvers include, but are not limited to, polyisobutylene, copolymers of ethylene and propylene, hydrogenated block copolymers of styrene and isoprene, polyacrylates (e.g., polymers and/or copolymers of various chain length acrylates), and polymethacrylates (e.g., polymers and/or copolymers of various chain length alkyl methacrylates). Generally, the viscosity index improver can be used in an amount of from 0.01 wt. % to 6 wt. %, from 0.01 to 5 wt. %, or from 0.01 to 4 wt. %, based upon the total weight of the fluid composition.

Dispersants are additives utilized to maintain oxidation products (produced during use of the fluid composition) in suspension in the fluid compositions to prevent the accumulation of debris that could score bearings, block lubricant pathways, prevent deposit formations, inhibit corrosive wear by neutralizing acidic products (e.g., combustion products), and other types of damage. Dispersants can be ash-containing or ashless in character. Dispersants can include, but are not limited to, alkenylsuccinic acid or anhydride derivatives (e.g., succinimides, succinate esters, or succinate ester amides), phenates, Mannich-Base condensates (e.g., the condensation products of alkylphenols, amines and aldehydes), hydrocarbyl substituted amines, sulfonates, sulfurized phenates, salicylates, naphthenates, stearates, carbamates, thiocarbamates, and phosphorus derivatives in metallic and non-metallic versions. Suitable dispersants can contain a polar group attached to a relatively high molecular weight hydrocarbon chain where the polar group contains at least one element of nitrogen, oxygen, or phosphorus. Patents describing dispersants which can be utilized in the fluid compositions include, but are not limited to, U.S. Pat. Nos. 3,036,003; 3,087,936; 3,172,892; 3,200,107; 3,219,666; 3,254,025; 3,272,746; 3,275,554; 3,322,670; 3,329,658; 3,316,177; 3,438,757; 3,341,542; 3,413,347; 3,438,757; 3,444,170; 3,449,250; 3,454,555; 3,454,607; 3,519,565; 3,541,012; 3,565,804; 3,630,904; 3,632,511; 3,652,616; 3,666,730; 3,687,849; 3,697,574; 3,702,300; 3,703,536; 3,704,308; 3,725,277; 3,725,480; 3,726,882; 3,751,365; 3,755,433; 3,756,953; 3,787,374; 3,798,165; 3,803,039; 3,822,209; 3,948,800; 4,100,082; 4,234,435; 4,426,305; 4,454,059; 4,767,551; and 5,705,458, among others. Generally, dispersants can be used in an amount from 0.1 wt. % to 18 wt. %, 0.1 wt. % to 15 wt. %, or 0.1 wt. % to 8 wt. %, based upon the total weight of the fluid composition.

Detergents are additives utilized to maintain overall cleanliness by keeping sludge, carbon and deposit precursors suspended in the fluid compositions. Many detergents are chemically similar to dispersants. Detergents which can be utilized in the fluid compositions can include the alkali or alkaline earth metal of sulfates, sulfonates, phenates, carboxylates, phosphates, carboxylic acids, and salicylates. For example, suitable detergents can include, but are not limited to, the sulfonated alkylaromatic hydrocarbons, alkyl phenols, sulfurized alkyl phenols treated with an alkaline earth metal hydroxide or oxide (e.g., CaO, Ca(OH)₂, BaO, Ba(OH)₂, MgO, or Mg(OH)₂). Sulfonated alkylaromatic compounds can be prepared from sulfonic acids obtained by sulfonation of C₉ to C₈₀ (or C₆ to C₆₀) alkyl substituted aromatic hydrocarbons (having one or more than one alkyl groups) where the alkyl groups independently can be C₃ to C₇₀ alkyl groups and the aromatic portion can be benzene, toluene, xylene, naphthalene, or biphenyl. Alkyl phenol and/or sulfurized alkyl phenols can have one or more C₄ to C₃₀ alkyl groups. The detergents utilized in the fluid compositions can be neutral (i.e., produced using only enough alkali or alkaline earth compound to neutralize the sulfonated alkylaromatic compound, alkyl phenol, or sulfurized alkyl phenol) or can be overbased (i.e., produced using more alkali or alkaline earth compound than necessary to neutralize the sulfonated alkylaromatic compound, alkyl phenol, or sulfurized alkyl phenol). Generally, detergents can be used in an amount from 0.01 wt. % to 6.0 wt. %, 0.05 wt. % to 5.0 wt. %, or 0.1 to 4 wt. %, based upon the total weight of the fluid composition.

Defoamants (or anti-foam agents) are additives utilized to retard the formation of stable foam in the fluid compositions. Defoamants which can be utilized in the fluid compositions can include, but are not limited to, silicone compounds (e.g., polysiloxanes, such as silicon oil or polydimethyl siloxane, among others) and organic polymers. Defoamants can be utilized in conjunction with demulsifiers. Generally, the maximum amount of defoamants can be 1 wt. %, 0.5 wt. %, or 0.1 wt. %, based upon the total weight of the fluid composition.

Antioxidants are additives utilized to retard the oxidative degradation of the alkanes or other oils in the fluid compositions. Oxidative degradation can produce deposits on metal surfaces, sludge, and/or increase the viscosity of the fluid composition. Antioxidants which can be utilized in the fluid compositions include, but are not limited to, hindered phenols (ashless); neutral or basic metal salts of hindered phenols; hindered phenolic carboxylic acid (e.g., propionic acid) ester derivatives; bis-hindered phenols; alkylated and non-alkylated aromatic amines; sulfurized alkyl phenols; alkali or alkaline earth metal salts of sulfurized alkyl phenols; copper dihydrocarbyl thio or dithio-phosphates; copper salts of carboxylic acids (natural or synthetic); and copper salts of dithiacarbamates, dithiocarbamates, sulphonates, phenates, acetylacetonates and alkenyl succinic acids or anhydrides (neutral, basic or acidic). Patents describing antioxidants which can be utilized in the fluid compositions include, but are not limited to, U.S. Pat. Nos. 4,798,684 and 5,084,197. Generally, the antioxidants can be used in an amount from 0.01 wt. % to 5 wt. %, from 0.01 to 2.5 wt. %, or from 0.01 wt. % to 1.5 wt. %, based upon the total weight of the fluid composition.

Anti-wear additives and extreme pressure additives are compounds utilized to reduce friction and wear of metal parts. Anti-wear additives and extreme pressure additives which can be utilized in the fluid compositions include, but are not limited to, metal alkylthiophosphates (e.g., a zinc alkylthiophosphonate having a C₁ to C₁₈ alkyl group), metal dialkyldithiophosphates (e.g., a zinc alkylthiophosphonate having C₁ to C₁₈ alkyl groups), sulfurized C₃ to C₃₀ aliphatic or arylaliphatic hydrocarbon olefins (acyclic or cyclic), polysulfides of thiophosphorus acids, polysulfides of thiophosphorus acid esters, phosphorothionyl disulfides, alkylthiocarbamoyl compounds (e.g., bis(dibutyl)thiocarbamoyl) in combination with a molybdenum compound (e.g., oxymolybdenum diisopropylphosphorodithioate sulfide) and a phosphorus ester (e.g., dibutyl hydrogen phosphite, for example), thiocarbamates, thiocarbamate/molybdenum complexes (e.g., moly-sulfur alkyl dithiocarbamate trimer complexes), and/or glycerol ester (e.g., mono-, di-, and tri-oleates, mono-palmitates and mono-myristates). Patents describing anti-wear additives and/or extreme pressure additives which can be utilized in the fluid compositions include, but are not limited to, U.S. Pat. Nos. 2,443,264; 2,471,115; 2,526,497; 2,591,577; 3,770,854; 4,501,678; 4,941,984; 5,034,141; 5,034,142; 5,084,197; and 5,693,598. Generally, the total amount of anti-wear additives and extreme pressure additives used in the fluid compositions can be from 0.01 wt. % to 8 wt. %, from 0.01 to 5 wt. %, or from 0.01 wt. % to 4 wt. %, based upon the total weight of the composition. In an aspect, the anti-wear additive is phosphorus-based.

Anti-rust additives are additives that protect lubricated metal surfaces against chemical attack by water or other contaminants. Anti-rust additives can function by 1) wetting the metal surface with a film of oil, 2) absorbing water into a water-in-oil emulsion, and/or 3) adhering to the metal to form a non-reactive surface, among other potential modes of function. Anti-rust additives which can be utilized in the fluid compositions include, but are not limited to, zinc dithiophosphates, metal phenolates, basic metal sulfonates, fatty acids, and amines. Generally, the amount of anti-rust additives used in the fluid compositions can be from 0.01 wt. % to 5 wt. %, from 0.01 wt. % to 2.5 wt. %, or from 0.01 wt. % to 1.5 wt. %, based upon the total weight of the composition.

Corrosion inhibitors are additives that reduce the degradation of metallic parts that are in contact with the fluid compositions. Corrosion inhibitors which can be utilized in the fluid compositions include, but are not limited to, thiadiazoles and triazoles. Patents describing corrosion inhibitors which can be utilized in the fluid compositions include, but are not limited to, U.S. Pat. Nos. 2,719,125; 2,719,126; and 3,087,932. Generally, the amount of corrosion inhibitors used in the fluid compositions can be from 0.01 wt. % to 5 wt. %, from 0.01 wt. % to 2.5 wt. %, or from 0.01 wt. % to 1.5 wt. %, based upon the total weight of the composition. The corrosion inhibitors also can improve anti-wear and EP properties.

Pour point depressants are additives that reduce the minimum temperature at which the fluid compositions will flow or can be poured. Pour point depressants which can be utilized in the fluid compositions include, but are not limited to, polymethacrylates, polyacrylates, polyarylamides, condensation products of haloparaffin waxes and aromatic compounds, vinyl carboxylate polymers, and terpolymers of dialkylfumarates, vinyl esters of fatty acids and allyl vinyl ethers. Patents describing pour point depressants which can be utilized in the fluid compositions include, but are not limited to, U.S. Pat. Nos. 1,815,022; 2,015,748; 2,191,498; 2,387,501; 2,655,479; 2,666,746; 2,721,877; 2,721,878; and 3,250,715. Generally, the amount of the pour point depressant used in the fluid compositions can be from 0.01 wt. % to 5 wt. %, from 0.01 wt. % to 2.5 wt. %, or from 0.01 wt. % to 1.5 wt. %, based upon the total weight of the composition.

Seal compatibility additives are compounds that swell elastomeric seals and can function by causing a chemical reaction in the fluid or a physical change in the seal elastomer. Seal compatibility additives which can be utilized in the fluid compositions include, but are not limited to, organic phosphates, aromatic esters, aromatic hydrocarbons, esters (e.g., butylbenzyl phthalate), and polybutenyl succinic anhydride. Generally, the amount of the seal compatibility additive used in the fluid composition can be from 0.01 wt. % to 3 wt. %, from 0.01 wt. % to 2.5 wt. %, or from 0.01 wt. % to 2 wt. %, based upon the total weight of the composition.

If desired, the alkane composition can be combined with one or more other base oils to form the fluid composition. One base oil can be used or two or more different base oils can be used. Generally, when a base oil is present in the fluid composition, but not specifically limited thereto, the amount of the base oil (or total base oils, if two or more) in the fluid composition is in a range from 1 to 45 wt. %; alternatively, from 5 to 40 wt. %; alternatively, from 5 to 25 wt. %; or alternatively, from 10 to 30 wt. %.

In an aspect, the base oil can be a Group I Base Oil, a Group II Base Oil, a Group III Base Oil, a Group IV Base Oil, or a Group V Base Oil, as well as any combination thereof. These base oil groups are those as designated by The American Petroleum Institute (API). In another aspect, the base oil can be a polyalphaolefin (i.e., a polyalphaolefin different from the alkane compositions described herein), a GTL fluid, or a combination thereof. Additional information on GTL fluids that optionally can be used in the fluid compositions disclosed herein can be found in “GTL—an emerging route to clean fuels and products,” Hydrocarbon Asia, Nov/December 2003, p. 44-49; “Shell gas-to-liquid (GTL) base oil converting natural gas to base oils for lubricants,” Shell Lubricants; and “The Shell GTL Process: Towards a World Scale Project in Qatar: the Pearl Project,” DGMK-Conference, Synthesis Gas Chemistry, Oct. 4-6, 2006, Dresden.

The alkane compositions and thus the resulting fluid composition disclosed herein can be used in a variety of formulations or products for a diverse range of applications and industries. As a non-limiting example, the fluid composition can be a lubricant composition, and the lubricant composition can be utilized in transmission or drive train fluids, which is inclusive of fluids or lubricants for transmissions (e.g., automobile and truck/bus manual/clutch transmissions and automatic transmissions, farm machinery transmissions), gear boxes (e.g., automobile and truck/bus gears, farm machinery gears), axle assemblies (e.g., transaxles, drive axles), differentials, as well as related hydraulic fluids (e.g., for farm equipment and construction vehicles); engine oils (e.g., for internal combustion engines such as gasoline or diesel or hybrid engines) in automobiles, trucks/busses, farm equipment, aircraft, and so forth; and greases (e.g., for any vehicle application such as automobiles, trucks/busses, farm equipment, aircraft). As another non-limiting example, the fluid composition can be an immersion coolant composition.

### Catalyst Systems and Oligomerization Processes

Low viscosity PAOs or alkane compositions consistent with aspects of this invention can be produced using any suitable catalyst system. Illustrative examples of catalyst systems that can be used to produce the disclosed compositions can contain BF₃; an alkylaluminum, an alkylaluminum halide, an aluminum trihalide, or any combination thereof; a supported metal oxide; an acidic ionic liquid; a metallocene compound; a clay, an acidic clay, or an acid washed clay; or an acidic ion exchange resin. Representative catalysts are described, for instance, in US 2020/0207682 A1.

A representative process that can be used to produce the alkane compositions can comprise contacting an olefin feedstock comprising at least 98 wt. % C₈ olefins (e.g., 95+ wt. % 1-octene) with a suitable catalyst system (e.g., a metallocene-based catalyst system) under oligomerization conditions to form an oligomer product, isolating a C₁₆ olefin product (or a C₂₄ olefin product, or a mixed C₁₆-C₂₄ olefin product) from the oligomer product using one or more separation steps, and hydrogenating the respective olefin product to produce the C₁₆ alkane composition (or the C₂₄ alkane composition, or the mixed C₁₆-C₂₄ alkane composition). Unreacted 1-octene monomer can also be isolated and recycled.

Any suitable oligomerization temperature, oligomerization reaction pressure, hydrogen partial pressure (if used), oligomerization reactor vessel (or vessels), catalyst system, catalyst deactivation technique, separation techniques (e.g., flashing, distillation, etc.), and hydrogenation process and catalyst can be utilized. These are exemplified in representative U.S. Pat. No. 8,536,391, 9,334,203, 9,745,230, 9,266,793, and 9,708,549.

### EXAMPLES

The invention is further illustrated by the following examples, which are not to be construed in any way as imposing limitations to the scope of this invention. Various other aspects, embodiments, modifications, and equivalents thereof which, after reading the description herein, may suggest themselves to one of ordinary skill in the art without departing from the spirit of the present invention or the scope of the appended claims.

Kinematic viscosities at 100° C. and 40° C. were determined using an Anton Paar Automatic Kinematic Viscometer SVM 3001 in accordance with ASTM D7042-04 (Stabinger viscometer method) at the respective temperatures, and the results are reported in centistokes (cSt). Pour point is a measurement of the temperature at which the sample will begin to flow under carefully controlled conditions. Pour point was determined using a CPP 5Gs Automated Cloud and Pour Point Analyzer in accordance with ASTM D5950 (automatic tilt method), and the results are reported in ° C. The flash point was determined using a PAC Herzog OptiFlash Cleveland Open Cup instrument in accordance with ASTM D92 (but with an electric ignition source instead of a gas flame), and the results are reported in ° C. Density was determined in accordance with ASTM D4052. A Flucon Thermal Conductivity meter was used to obtain the thermal conductivity in accordance with ASTM D7896-19.

Example 1 was a distilled C₈ dimer fraction isolated from a metallocene-catalyzed 1-octene oligomerization reaction product, which was then hydrogenated to form a C₁₆ alkane composition. Example 1 contained approximately 95-98 wt. % hydrogenated 1-octene dimers (and approximately 95-98 wt. % C₁₆ alkanes).

Example 2 was a distilled C₈ trimer fraction isolated from a metallocene-catalyzed 1-octene oligomerization reaction product, which was then hydrogenated to form a C₂₄ alkane composition. Example 2 contained approximately 95-98 wt. % hydrogenated 1-octene trimers (and approximately 95-98 wt. % C₂₄ alkanes).

Example 3 was a mixture of C₈ oligomers isolated from a metallocene-catalyzed 1-octene oligomerization reaction product, which was then hydrogenated to form a C₁₆-C₂₄ alkane composition (with some C₃₂ alkanes).

To fractionate samples of the metallocene-catalyzed 1-octene oligomerization reaction product, a BR Instrument D2892 Crude Oil Distillation System was utilized. The vacuum was set to 10 torr and the heater was set to 100% until 95° C., at which point the heater was reduced to 65%. The distillation was stopped after all of the light components had been distilled (approximately 1-2% of the total volume). A more intensive distillation was used to isolate the C₁₆ and C₂₄ fractions. In this case, the vacuum was set to 10 torr and the heater was set to 100% until 95° C., at which point the heater was reduced to 65%. The C₁₆ fraction was collected when the overhead temperature was in the 142-162° C. range. The C₂₄ fraction was collected when the overhead temperature was in the 215-235° C. range. GC analysis was used to confirm the clean fractionation of the samples.

Samples were hydrogenated in a Zipperclave reactor using 6 wt. % Johnson Matthey HTC Ni 500 hydrogenation catalyst at 900 psig H₂ and 200° C. for 6 hr. Full hydrogenation of the fractions was confirmed by testing the alkane composition sample by bromine index.

Comparative Example 4 (Example C4) was a nominal 2 cSt (KV100) PAO based on 1-decene dimers (PAO 2). Comparative Example 5 (Example C5) was a nominal 2.5 cSt (KV100) PAO based on 1-dodecene dimers (PAO 2.5). Comparative Example 6 (Example C6) is hexadecane (a C₁₆ alkane).

Properties of these examples are summarized in Table 1. Referring first to the C₁₆ alkane composition of Example 1, as compared to Example C4 (C₁₀ dimer, PAO 2), Example 1 beneficially has lower viscosity (KV100 and KV40) and a significantly lower density. As compared to Example C6 (hexadecane) with the same carbon number and comparable viscosity, Example 1 has a much lower pour point, thus indicating that the composition of Example 1 will remain in the liquid phase over a much wider temperature range than that of Example C6. With approximately 5 wt. % of either C₈ or C₂₄ in Example 1, typical values of KV100 (cSt) are 1.1-1.22, KV40 (cSt) are 2.6-3.0, density @ 15° C. (g/cc) are 0.776-0.779, pour point (° C.) are −42 to −47, and flash point (° C.) are 120-130.

Referring now to the C₂₄ alkane composition of Example 2, as compared to Example C5 (C12 dimer, PAO 2.5), Example 2 has similar viscosity in combination with a beneficially lower density. Unexpectedly, Example 2 also has both a lower pour point and a higher flash point than that of Example C5, at the same carbon number, thus indicating that Example 2 will remain in the liquid phase over a much wider temperature range than that of Example C5. Also unexpectedly, Example 2 has both a lower pour point and a higher flash point than that of Example C4 (C₁₀ dimer, PAO 2). With approximately 5 wt. % of either C₁₆ or C₃₂ in Example 2, typical values of KV100 (cSt) are 2.35-2.55, KV40 (cSt) are 8.2-9.1, density @ 15° C. (g/cc) are 0.802-0.804, pour point (° C.) are −76 to −86, and flash point (° C.) are 188-198.

Referring now to the C₁₆-C₂₄ alkane composition of Example 3, as compared to Example C4 (C₁₀ dimer, PAO 2), Example 3 beneficially has lower viscosity (KV100 and KV40) and a significantly lower density. Depending upon the relevant amounts of dimer, trimer, and tetramer, the pour point and flash point of the alkane composition of Example 3 approach the values for Example C4 (C₁₀ dimer, PAO 2).

Table 2 summarizes the compositional breakdown of eighteen (18) different C₁₆-C₂₄ (and some C₃₂) olefin compositions (labeled A thru R), which were mixtures of C₈ oligomers isolated from a metallocene-catalyzed 1-octene oligomerization reaction product, but prior to hydrogenation (e.g., as in Example 3). For these 18 experiments, the dimer (C₁₆ olefin) content was in the 63-82 wt. % range, the trimer (C₂₄ olefin) content was in the 12-27 wt. % range, and the tetramer (C₃₂ olefin) content was in the 1-6 wt. % range. The dimers, trimers, and tetramers of these examples account for approximately 94-99 wt. % of the composition. Of the remainder, the majority is <C₁₄ hydrocarbons, including residual 1-octene (monomer) reactant. Depending upon the relative dimer (C₁₆ olefin) and trimer (C₂₄ olefin) content, the values of KV100, KV40, density, pour point, and flash point can effectively range from that of Example 1 to Example 2. The weight percentages in Table 2 were determined via gas chromatography with a mass detector, in particular, a 7890A/5979C GCMS equipped with a ZB-5HT Inferno 30Mx250 μmX0, 10 μm column with a flow of 1 mL/min with a 10 min hold time at 35° C., then a ramp of 20° C./min to 380° C., and then a 3 min hold time.

TABLE 1
Properties of Examples 1-3 and Comparative Examples C4-C6.

| Property | Example 1 | Example 2 | Example 3 | C4 | C5 | C6 |
|---|---|---|---|---|---|---|
| General description | C₁₆ alkanes | C₂₄ alkanes | C₁₆-C₂₄ | C₁₀ dimer | C₁₂ dimer | Hexadecane |
| | | | alkanes | PAO | PAO | |
| KV100 (cSt) | 1.17 | 2.45 | 1.29 | 1.7 | 2.4 | 1.2 |
| KV40 (cSt) | 2.8 | 8.7 | 3.2 | 5.1 | 8.3 | 2.9 |
| Density @ 15° C. | 0.7775 | 0.8035 | 0.7805 | 0.7974 | 0.8064 | 0.77 |
| (g/ce) | | | | | | |
| Pour point (° C.) | −44 | −83 | −69 | −73 | −52 | 18* |
| Flash point (° C.) | 128 | 196 | 140 | 158 | 180 | 137 |
| Noack Volatility | 64% | 8% | 40% | 15.8% | 6% | — |
| (at 200° C.) | | | | | | |
| Thermal Conductivity | 142 | 146 | 145 | 144 | 150 | — |
| (at 0° C., mW/m*K) | | | | | | |
| Specific Heat | 1972 | 1940 | 1975 | 1938 | 1981 | — |
| (at 0° C., J/kg*K) | | | | | | |

*Literature melting point

TABLE 2
Oligomer product content of C₁₆-C₂₄ olefin compositions of Examples A-R.

| Component | A | B | C | D | E | F | G | H | I |
|---|---|---|---|---|---|---|---|---|---|
| 1-octene dimers-C₁₆ | 71.9 | 74.4 | 73.9 | 73.6 | 73.1 | 70.3 | 67.6 | 69.3 | 63.4 |
| 1-octene trimers-C₂₄ | 20.9 | 18.3 | 19.7 | 20.5 | 20.0 | 20.9 | 25.1 | 23.4 | 26.3 |
| 1-octene tetramers-C₃₂ | 3.7 | 3.8 | 3.0 | 4.1 | 3.7 | 4.6 | 5.6 | 4.8 | 6.5 |
| Component | J | K | L | M | N | O | P | Q | R |
| 1-octene dimers-C₁₆ | 78.5 | 75.6 | 81.1 | 80.2 | 73.1 | 73.8 | 69.8 | 74.8 | 79.4 |
| 1-octene trimers-C₂₄ | 16.7 | 17.8 | 12.3 | 13.3 | 21.5 | 21.7 | 25.3 | 21.2 | 17.6 |
| 1-octene tetramers-C₃₂ | 1.9 | 1.9 | 1.3 | 1.3 | 4.7 | 3.8 | 4.4 | 3.2 | 2.1 |

The invention is described above with reference to numerous aspects and embodiments, and specific examples. Many variations will suggest themselves to those skilled in the art in light of the above detailed description. All such obvious variations are within the full intended scope of the appended claims. Other aspects of the invention can include, but are not limited to, the following (aspects are described as “comprising” but alternatively, can “consist essentially of” or “consist of”):

Aspect 1. An alkane composition comprising at least 90 wt. % (or least 92 wt. %, at least 95 wt. %, at least 97 wt. %, at least 98 wt. %, or at least 99 wt. %) C₁₆ alkanes (hydrogenated 1-octene dimers) and characterized by: a 100° C. kinematic viscosity (KV100) in a range from 0.9 to 1.5 cSt, a 40° C. kinematic viscosity (KV40) in a range from 2 to 3.6 cSt, and a flash point in a range from 115 to 140° C. and/or a pour point in a range from −60 to −30° C.

Aspect 2. The composition defined in aspect 1, wherein the KV100 (100° C. kinematic viscosity) is in any range disclosed herein, e.g., from 1 to 1.5 cSt, from 1 to 1.4 cSt, from 1 to 1.3 cSt, from 1.1 to 1.5 cSt, from 1.1 to 1.4 cSt, or from 1.1 to 1.3 cSt.

Aspect 3. The composition defined in aspect 1 or 2, wherein the KV40 (40° C. kinematic viscosity) is in any range disclosed herein, e.g., from 2 to 3.4 cSt, from 2.2 to 3.6 cSt, from 2.2 to 3.4 cSt, from 2.4 to 3.4 cSt, from 2.4 to 3.2 cSt, from 2.4 to 3 cSt, from 2.6 to 3.2 cSt, from 2.6 to 3 cSt, or from 2.7 to 2.9 cSt.

Aspect 4. The composition defined in any one of the preceding aspects, wherein the flash point is in any range disclosed herein, e.g., from 115 to 135° C., from 115 to 130° C., from 120 to 140° C., from 120 to 135° C., from 120 to 130° C., from 125 to 135° C., or from 125 to 130° C.

Aspect 5. The composition defined in any one of the preceding aspects, wherein the pour point is in any range disclosed herein, e.g., from −60 to −35° C., from −60 to −40° C., from −55 to −30° C., from −55 to −35° C., from −55 to −40° C., from −50 to −30° C., from −50 to −35° C., or from −50 to −40° C.

Aspect 6. The composition defined in any one of the preceding aspects, wherein the composition is further characterized by a density at 15° C. in any range disclosed herein, e.g., from 0.773 to 0.782 g/cc, from 0.774 to 0.781 g/cc, from 0.775 to 0.780 g/cc, from 0.776 to 0.779 g/cc, from 0.776 to 0.778 g/cc, from 0.777 to 0.779 g/cc, or from 0.777 to 0.778 g/cc.

Aspect 7. An alkane composition comprising at least 90 wt. % (or least 92 wt. %, at least 95 wt. %, at least 97 wt. %, at least 98 wt. %, or at least 99 wt. %) C₂₄ alkanes (hydrogenated 1-octene trimers) and characterized by: a 100° C. kinematic viscosity (KV100) in a range from 2 to 3 cSt, a 40° C. kinematic viscosity (KV40) in a range from 7.7 to 9.7 cSt, and a flash point in a range from 185 to 215° C. and/or a pour point in a range from −95 to −70° C.

Aspect 8. The composition defined in aspect 7, wherein the KV100 (100° C. kinematic viscosity) is in any range disclosed herein, e.g., from 2.1 to 2.9 cSt, from 2.2 to 2.8 cSt, from 2.3 to 2.7 cSt, from 2.3 to 2.6 cSt, from 2.3 to 2.5 cSt, from 2.4 to 2.7 cSt, from 2.4 to 2.6 cSt, or from 2.4 to 2.5 cSt.

Aspect 9. The composition defined in aspect 7 or 8, wherein the KV40 (40° C. kinematic viscosity) is in any range disclosed herein, e.g., from 7.8 to 9.6 cSt, from 7.9 to 9.5 cSt, from 8 to 9.4 cSt, from 8.1 to 9.3 cSt, from 8.2 to 9.2 cSt, from 8.3 to 9.1 cSt, from 8.4 to 9 cSt, from 8.5 to 8.9 cSt, or from 8.6 to 8.8 cSt.

Aspect 10. The composition defined in any one of aspects 7-9, wherein the flash point is in any range disclosed herein, e.g., from 185 to 205° C., from 185 to 200° C., from 188 to 202° C., from 190 to 215° C., from 190 to 205° C., from 192 to 200° C., or from 194 to 198° C.

Aspect 11. The composition defined in any one of aspects 7-10, wherein the pour point is in any range disclosed herein, e.g., from −90 to −70° C., from −90 to −75° C., from −88 to −75° C., from −88 to −78° C., or from −85 to −80° C.

Aspect 12. The composition defined in any one of aspects 7-11, wherein the composition is further characterized by a density at 15° C. in any range disclosed herein, e.g., from 0.799 to 0.808 g/cc, from 0.800 to 0.807 g/cc, from 0.801 to 0.806 g/cc, from 0.802 to 0.805 g/cc, from 0.802 to 0.804 g/cc, from 0.803 to 0.805 g/cc, or from 0.803 to 0.804 g/cc.

Aspect 13. An alkane composition comprising: (a) from 5 to 95 wt. % C₁₆ alkanes (hydrogenated 1-octene dimers), and (b) from 95 to 5 wt. % C₂₄ alkanes (hydrogenated 1-octene trimers), based on a total weight of the C₁₆ alkanes and the C₂₄ alkanes.

Aspect 14. The composition defined in aspect 13, wherein the composition comprises any amount of the C₁₆ alkanes disclosed herein, e.g., from 10 to 90 wt. %, from 50 to 90 wt. %, from 15 to 85 wt. %, from 50 to 85 wt. %, from 25 to 75 wt. %, or from 35 to 65 wt. %, of the C₁₆ alkanes, based on a total weight of the C₁₆ alkanes and the C₂₄ alkanes.

Aspect 15. The composition defined in aspect 13 or 14, wherein the alkane composition comprises: (a) from 40 to 90 wt. %, from 50 to 85 wt. %, from 55 to 95 wt. %, or from 58 to 80 wt. % of the C₁₆ alkanes (hydrogenated 1-octene dimers), and (b) from 10 to 60 wt. %, from 10 to 50 wt. %, from 10 to 30 wt. %, or from 14 to 30 wt. % of the C₂₄ alkanes (hydrogenated 1-octene trimers), based on a total weight of the composition.

Aspect 16. The composition defined in any one of aspects 13-15, wherein the alkane composition further comprises (c) from 0.5 to 20 wt. %, from 1 to 12 wt. %, from 1 to 9 wt. %, or from 2 to 8 wt. % C₃₂ alkanes (hydrogenated 1-octene tetramers), based on a total weight of the composition.

Aspect 17. The composition defined in any one of aspects 13-16, wherein the composition has a KV100 (100° C. kinematic viscosity) in any range disclosed herein, e.g., from 1 to 2.9 cSt, from 1 to 2.5 cSt, from 1 to 2 cSt, from 1 to 1.6 cSt, from 1.1 to 2.5 cSt, from 1.1 to 2 cSt, from 1.1 to 1.6 cSt, from 1.2 to 2.5 cSt, from 1.2 to 2 cSt, from 1.3 to 2.9 cSt, or from 1.3 to 2.5 cSt.

Aspect 18. The composition defined in any one of aspects 13-17, wherein the composition has a KV40 (40° C. kinematic viscosity) in any range disclosed herein, e.g., from 2 to 9.5 cSt, from 2 to 8.5 cSt, from 2.5 to 8.5 cSt, from 2.5 to 7 cSt, from 2.5 to 5 cSt, from 2.5 to 4 cSt, from 3 to 8 cSt, from 3 to 6 cSt, from 4 to 9 cSt, or from 4 to 6 cSt.

Aspect 19. The composition defined in any one of aspects 13-18, wherein the composition has a flash point in any range disclosed herein, e.g., from 100 to 200° C., from 100 to 150° C., from 120 to 180° C., from 120 to 160° C., from 130 to 190° C., from 130 to 160° C., or from 140 to 180° C.

Aspect 20. The composition defined in any one of aspects 13-19, wherein the composition has a pour point in any range disclosed herein, e.g., from −85 to −35° C., from −80 to −40° C., from −75 to −40° C., from −75 to −45° C., or from −70 to −45° C.

Aspect 21. The composition defined in any one of aspects 13-20, wherein the composition has a density at 15° C. in any range disclosed herein, e.g., from 0.776 to 0.805 g/cc, from 0.778 to 0.803 g/cc, from 0.778 to 0.790 g/cc, from 0.780 to 0.803 g/cc, from 0.780 to 0.800 g/cc, from 0.780 to 0.795 g/cc, or from 0.780 to 0.790 g/cc.

Aspect 22. A fluid composition comprising the alkane composition defined in any one of the preceding aspects and an additive.

Aspect 23. The fluid composition defined in aspect 22, wherein the additive comprises an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, a thickener, or any combination thereof.

Aspect 24. The fluid composition defined in aspect 22 or 23, wherein the fluid composition is a lubricant composition or an immersion coolant composition.

We claim:

1. An alkane composition comprising:
(a) from 5 to 95 wt. % C₁₆ alkanes (hydrogenated 1-octene dimers); and
(b) from 95 to 5 wt. % C₂₄ alkanes (hydrogenated 1-octene trimers), based on a total weight of the C₁₆ alkanes and the C₂₄ alkanes.

2. The composition of claim 1, wherein the composition comprises an amount of the C₁₆ alkanes in a range from 10 to 90 wt. %, based on the total weight of the C₁₆ alkanes and the C₂₄ alkanes.

3. The composition of claim 1, wherein the alkane composition comprises:
(a) from 40 to 90 wt. % of the C₁₆ alkanes (hydrogenated 1-octene dimers); and
(b) from 10 to 60 wt. % of the C₂₄ alkanes (hydrogenated 1-octene trimers),
based on a total weight of the composition.

4. The composition of claim 3, wherein the alkane composition further comprises (c) from 0.5 to 20 wt. % C₃₂ alkanes (hydrogenated 1-octene tetramers), based on the total weight of the composition.

5. The composition of claim 1, wherein the composition has:
a KV100 (100° C. kinematic viscosity) in a range from 1 to 2.9 cSt;
a KV40 (40° C. kinematic viscosity) in a range from 2 to 9.5 cSt;
a flash point in a range from 100 to 200° C.;
a pour point in a range from −85 to −35° C.; and
a density at 15° C. in a range from 0.776 to 0.805 g/cc.

6. The composition of claim 1, wherein the composition has:
a KV100 (100° C. kinematic viscosity) in a range from 1 to 2 cSt;
a KV40 (40° C. kinematic viscosity) in a range from 2 to 8.5 cSt;
a flash point in a range from 120 to 180° C.;
a pour point in a range from −80 to −40° C.; and
a density at 15° C. in a range from 0.778 to 0.803 g/cc.

7. The composition of claim 1, wherein the composition has:
a KV100 (100° C. kinematic viscosity) in a range from 1.1 to 2.5 cSt;
a KV40 (40° C. kinematic viscosity) in a range from 2.5 to 7 cSt;
a flash point in a range from 130 to 190° C.;
a pour point in a range from −75 to −40° C.; and
a density at 15° C. in a range from 0.780 to 0.803 g/cc.

8. The composition of claim 1, wherein the composition has:
a KV100 (100° C. kinematic viscosity) in a range from 1.2 to 2.5 cSt;
a KV40 (40° C. kinematic viscosity) in a range from 3 to 6 cSt;
a flash point in a range from 130 to 160° C.;
a pour point in a range from −75 to −45° C.; and
a density at 15° C. in a range from 0.780 to 0.800 g/cc.

9. The composition of claim 1, wherein the composition has:
a KV100 (100° C. kinematic viscosity) in a range from 1.3 to 2.5 cSt;
a KV40 (40° C. kinematic viscosity) in a range from 4 to 9 cSt;
a flash point in a range from 140 to 180° C.;
a pour point in a range from −70 to −45° C.; and
a density at 15° C. in a range from 0.780 to 0.795 g/cc.

10. A fluid composition comprising the alkane composition of claim 1 and an additive.

11. The fluid composition of claim 10, wherein the additive comprises an anti-wear additive, a dispersant, a viscosity modifier, a friction modifier/reducer, a detergent, a demulsifier, a defoamant, an antioxidant, an extreme pressure agent, a rust/corrosion inhibitor, a metal passivator, a pour point depressant, a thickener, or any combination thereof.

12. The fluid composition of claim 11, wherein the fluid composition is a lubricant composition or an immersion coolant composition.

13. An alkane composition comprising at least 90 wt. % C₁₆ alkanes (hydrogenated 1-octene dimers) and characterized by:
a 100° C. kinematic viscosity (KV100) in a range from 0.9 to 1.5 cSt;
a 40° C. kinematic viscosity (KV40) in a range from 2 to 3.6 cSt; and
a flash point in a range from 115 to 140° C. and/or a pour point in a range from −60 to −30° C.

14. The composition of claim 13, wherein the KV100 is in a range from 1 to 1.4 cSt.

15. The composition of claim 13, wherein the KV40 is in a range from 2.2 to 3.4 cSt.

16. The composition of claim 13, wherein:
the flash point is in a range from 120 to 135° C.; and
the pour point is in a range from −55 to −35° C.

17. The composition of claim 13, wherein the alkane composition comprises at least 95 wt. % of the C₁₆ alkanes (hydrogenated 1-octene dimers).

18. The composition of claim 13, wherein the alkane composition is further characterized by a density at 15° C. in a range from 0.773 to 0.782 g/cc.

19. An alkane composition comprising at least 90 wt. % C₂₄ alkanes (hydrogenated 1-octene trimers) and characterized by:
a 100° C. kinematic viscosity (KV100) in a range from 2 to 3 cSt;
a 40° C. kinematic viscosity (KV40) in a range from 7.7 to 9.7 cSt; and
a flash point in a range from 185 to 215° C. and/or a pour point in a range from −95 to −70° C.

20. The composition of claim 19, wherein:
the KV100 is in a range from 2.1 to 2.9 cSt;
the KV40 is in a range from 7.8 to 9.6 cSt;
the flash point is in a range from 185 to 205° C.; and
the pour point is in a range from −90 to −70° C.
